(19) United States
(12) Patent Application Publication
(10) Pub. No.: US 2009/0240802 A1
(43) Pub. Date: Sep. 24, 2009

(54) METHOD AND APPARATUS FOR SELF TUNING NETWORK STACK

(75) Inventor: Ganesh Handige SHANKAR, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY L.P., Houston, TX (US)

(21) Appl. No.: 12/114,892

(22) Filed: May 5, 2008

(30) Foreign Application Priority Data
Mar. 18, 2008 (IN) 668/CHE/2008

(51) Int. Cl. G06F 15/173

(52) U.S. Cl. 709/224

(57) ABSTRACT

A method and apparatus for tuning a computer network by detecting different workload patterns. One embodiment of the method provides a system configuration analyzer to collect data regarding network configuration and tuning parameters, a workload analyzer to collect and store data relating to tuning such as network traffic information, a system tuner to determine whether there is a change in workload and whether tuning is necessary. Another embodiment of the method provides tuning policies that would instruct the system tuner to perform certain actions if the system tuner determines that tuning is necessary.

### BACKGROUND

This innovation relates to a method and apparatus for automatically and dynamically tuning a computer network by detecting different workload patterns.

With the increasingly complex computer networks being used, network performance becomes one of the important factors that would affect the efficiency of a computer system, for example, a enterprise data center.

Typical enterprise data center servers usually have multiple uses. For example, enterprise data center servers may be used as web servers, application servers, database servers, DNS servers, etc. In order to optimize the performance of the network, it is necessary to tune the networking stack. However, the way to tune the computer network is different for different kind of workloads. To complicate the process of tuning the network, the workload of the server may change many times during a single day. For example, a server may be running an OLTP type of workload during working hours and running bulk data transfer during overnight hours. The way to tune the network is very different for different types of workload is partly because the network traffic for different workload is different.

Optimizing network performance is one of the important aspect of e-business architecture that are often used within an enterprise data centers. Typically, different kinds of workloads may exist simultaneously in a datacenter. Some examples of the workloads are web server workloads, OLTP workloads, decision support workloads, business intelligence workloads, DNS workloads, mailer workloads, backup workloads, or other over network kind of workloads. Due to the nature of the usage of computer systems, the types of workload may change multiple times during different times of the day, different times of the week, different times of the month, or different times of the year. For example, the workload of may be predominantly OLTP type during day time and may switch to back up during evening or night hours.

Because of the changing workload, a static method of tuning a computer system is not an optimal way to tune a computer system. Moreover, different kinds of workloads may have conflicting tuning parameters, making a static method of tuning a computer system undesirable.

Therefore, it would be desirable to have a method of automatically and dynamically tune the network based on different workload patterns.

### BRIEF DESCRIPTION OF THE DRAWINGS

The method and apparatus or self tuning network stack are further described with reference to the accompanying drawings in which:

FIG. 1 is a block diagram showing an exemplary method and apparatus for tuning a computer system.

FIG. 2 is a flow diagram showing an exemplary method and apparatus for tuning a computer system.

### DETAILED DESCRIPTION OF THE EMBODIMENTS

The embodiments of the present innovation provide a method and apparatus for tuning a computer network by detecting different workload patterns.

The embodiments utilize one or more analyzers to collect and analyze various data that is related to the tuning of the computer network. For example, a workload analyzer may collect and analyze network traffic data, a system configuration analyzer may collect data regarding different network configurations and parameters. These analyzers may collect and store the data in a database, then analyze the data and invoke a system tuner. The system tuner may tune the system based on the data collected and analyzed by the various analyzers. In addition, tuning policies may be set to further optimize the tuning process. For example, the tuning policies may include enabling or disabling automatic tuning during certain circumstances, tuning the system in a particular way based on different thresholds, etc.

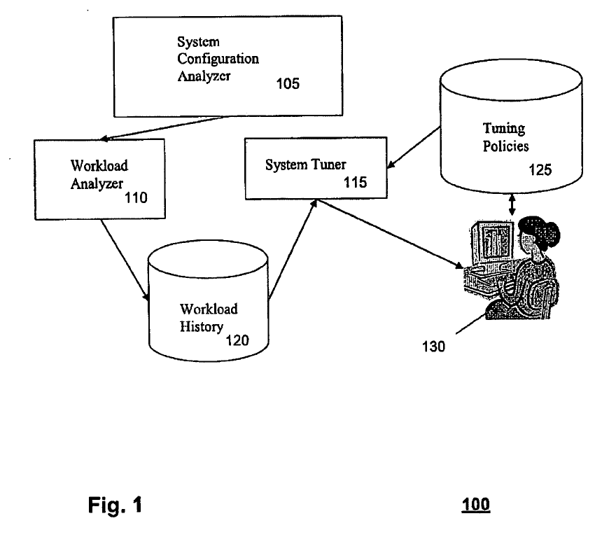

In an exemplary embodiment, the method for tuning the computer system may be illustrated by the block diagram of FIG. 1. The tuning system 100 comprises a system configuration analyzer 105, a workload analyzer 110, a workload history database 120, a system tuner 115, and a tuning policies database 125. In this exemplary embodiment, the system configuration analyzer 105 may run initially. The system configuration analyzer 105 may collect the data that may be required to tune the system. For example, the system configuration analyzer 105 may collect the data regarding how the system is currently being tuned.

Following FIG. 1, the workload analyzer 110 may run periodically to gather network traffic patterns and store these network traffic patterns in workload history database 120. Different network traffic patterns would indicate how the system is being used. For example, in a typical e-commerce transaction, there may be a pattern of one or more request packet and one or more response packet. On the other hand, in a typical back-up over network kind of transactions, the flow of packets is more likely to be predominantly unidirectional. To obtain optimal efficiency of the system, different usage may require different tuning of the system.

Further in FIG. 1, the system tuner 115 may then run periodically to gather data stored in the workload history database 120 to determine if workload of the system has changed. In addition, the system tuner 125 may also gather data stored in the tuning policies database 125. For example, if the system tuner 125 determines there is a workload shift, the system tuner may examine the data gathered by the system configuration analyzer 105 to see if the system is currently optimally tuned. Alternatively, if the system has been tuned before, whether it is tuned automatically by the system tuner 125 or through the action of administrator 130, the system tuner 125 would already have the data regarding how the system is being tuned. In another alternative, the system tuner 125 may invoke the system configuration analyzer 105 to gather data regarding how the system is currently tuned.

If the system tuner 125 determines the system is not currently optimally tuned, it may then look to the tuning policies to determine if there are further instructions. For example, the tuning policies may instruct the system tuner 125 to raise a warning for the system administrator 130. In addition to raising a warning, the tuning policies may instruct the system tuner 125 to make suggestions to the system administrator 130 regarding how to optimally tune the system. In another example, the tuning policies may instruct the system tuner 125 to automatically tune the system. In some other examples, the tuning policies may instruct the system 125 to wait for a certain period time before making any actions. For example, if there is a change in network traffic pattern for only a very short period of time, then it may not be necessary to tune the system. Therefore, the tuning policies may instruct the system tuner 125 to wait to see if the change in network traffic pattern is long term before taking any action. In other examples, the tuning policies may instruct the system tuner not to take any action at all. The tuning policies may be set by the administrator 130, or some other processes depending on the computer system being tuned.

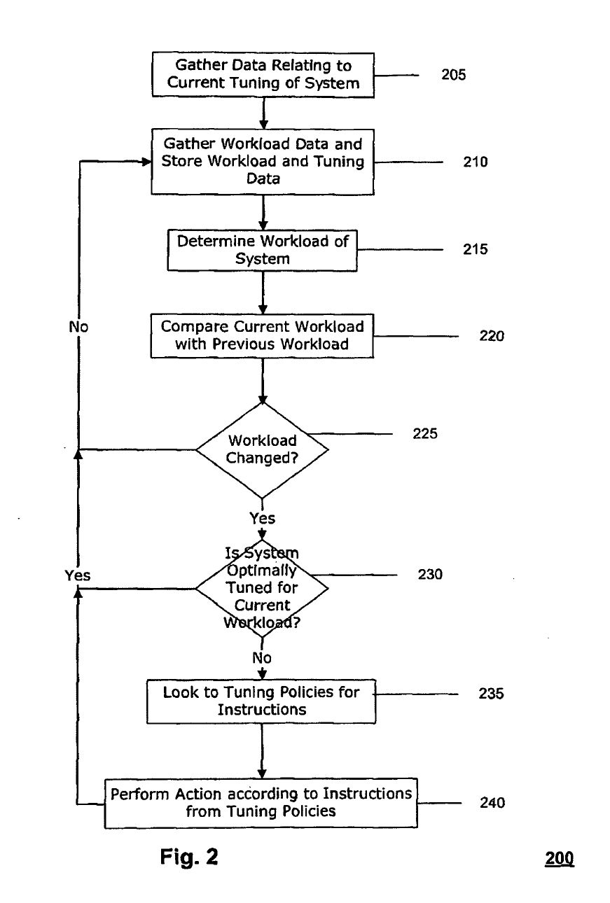

Another embodiment may be illustrated by the flow diagram of FIG. 2. According to FIG. 2, the system begins by gathering data relating to current tuning of the system at block 205, this process may gather information on how the system is currently being tuned. The process then proceeds to block 210, where data relating to workload and tuning is gathered and stored. The process may gather data such as network traffic data, and other types of data that may relate to the usage of the computer system. The process then proceeds to block 215, where the workload of the system is determined based on the gathered data in block 210. Because certain workload maybe reflected by the network traffic pattern, the system may determine what the computer system is being used for based on the network traffic pattern. The process may further store the workload with the data collected in block 210, or the process may store the workload in a separate database or other storage mechanism. The process then proceeds to block 220, where the current workload is being compared with the previous workload.

Following the flow diagram of FIG. 2, the process now proceeds to block 225 where a determination is made whether the workload has changed. If the determination indicates that the workload has not changed, then the process reverts back to block 210. This may take place after a certain delay. For example, the process may not revert back until 5 seconds later. On the other hand, if the determination indicates that the workload has changed, the process proceeds to block 230 where a determination is made whether the system is optimally tuned for the current workload. If the determination indicates that the system is optimally tuned for the current workload, the process reverts back to block 210. Similar to the process in block 225, this may take place after a certain delay. For example, the process may not revert back until it is time to repeat the entire process again.

If the determination indicates that the system is not optimally tuned for the current workload, the process then proceeds to read the tuning policies for instructions on what action to take. The tuning policies may instruct the process to automatically tune the system. The tuning policies may instruct the process to make recommendation to the administrator on how to tune the system. For example, the process may instruct the administrator to change a certain tuning parameter from one value to another value. If the system has been tuned, whether automatically by the process or manually by the administrator, i.e. if any of the tuning parameters have been changed, the process may store the tuning parameters such that when the process repeats, the process would now have data regarding how the system is currently tuned.

Alternatively, the tuning policies may instruct the process not to take any action for a period of time, during which time the process may obtain more data to determine if the change in workload is not temporary. If the change in workload is not temporary, then the process may proceed to follow other instructions in the tuning policies regarding what action to take. If the change in workload is only temporary, then there would be no need to take any action.

The method and apparatus for tuning a computer network may be used in any computer systems. The method and apparatus for tuning a computer system in the present embodiments involve automatically and dynamically tuning a computer system by detecting the workload of the computer system. In one exemplary embodiment, the tuning method and apparatus comprises one or more workload analyzers (e.g. block 110 in FIG. 1), one or more system configuration analyzers (e.g. block 105 in FIG. 1), one or more workload history database (e.g. block 120 in FIG. 1), one or more tuning policies (e.g. block 125 in FIG. 1) and system tuners (e.g. block 115 in FIG. 1). In other exemplary embodiments, the tuning method and apparatus may not necessarily comprises all the analyzers, databases, policies and tuners. For example, the tuning method and apparatus may comprise only a workload analyzer and no tuning policies. Selecting the components to include in the tuning method and apparatus depends on the type of computer system and the usage of the computer system. Different types of computer systems may be tuned using different selection of components. In addition, these components may be enabled or disabled for various different tuning purposes.

In one exemplary embodiment, the system configuration analyzer collects data that is pertinent to making tuning choices. For example, the system configuration analyzer may collect data such as network configurations, current tuning parameters, interrupt coalescence tunable parameters, interrupt configurations, and other hardware and/or operating system information. The system configuration analyzer may run once initially; alternatively, the system configuration analyzer may be invoked whenever necessary.

The workload analyzer collects data relating to network traffic patterns and other traffic information. The workload analyzer may store the collected network traffic data in a history database, or any other form of data storage. The workload analyzer may run continuously, periodically, manually, or according to a particular custom schedule.

Similarly, the system tuner may run continuously, periodically, manually or according to a particular schedule. The system tuner is responsible for the actual tuning of the system based on the data collected and analyzed by the various analyzers and the tuning policies. In one embodiment, the data collected and tuning policies may be analyzed by any of the system configuration analyzers, workload analyzers, or the system tuner. For example, if the system tuner analyzes the data collected by the workload analyzers and the data collected by the system configuration analyzers, then determines that the workload pattern is not currently optimally tuned, the system tuner may tune the system to suit the workload.

In addition to the various analyzes, tuning policies may also be used to further assist in tuning the computer system. For example, the tuning policies may comprise a set of policies for system tuning set by an administrator. These tuning policies may comprise different modes, thresholds, or other rules. An example of a tuning policy would be to enable or disable automatic system tuning during certain circumstances. Another example of a tuning policy would be to run automatic tuning in advisory mode, or, in the alternative, the tuning policy may instruct the system tuner to provide suggestions or recommendations for the administrator on how to tune to system or perform other functionalities. In another words, if the system tuner determines that the workload is not currently optimally tuned, it may then look at the tuning policy for further instructions, if any. The tuning policies may instruct the system tuner to automatically tune the system; or raise an alert for the administrator; or make suggestions to the administrator as to how to optimally tune the system; or the tuning policies may simply instruct the system tuner to wait and not take any action. For example, if there is a sudden change in network traffic pattern for a short period of time, the system tuner may want to wait to see if the change in network traffic pattern lasts long enough to make system tuning necessary.

In an exemplary embodiment, a system configuration analyzer runs initially. The system configuration analyzer collects data that is pertinent to the tuning of the computer system. The nature of the data being collected by the system configuration analyzer may depend on the hardware, the operating system, the usage of the system, etc. Different kinds of computer system may have different data that is pertinent to the tuning of the computer system. For example, the system configuration analyzer may collect system information such as configured LAN interfaces, current set of system tunable parameters, interrupt configuration details, interrupt coalescence values, etc. After the system configuration analyzer performed the collection of data, the workload analyzer may be invoked.

In an exemplary embodiment, the workload analyzer may run continuously or periodically in the background and collect network traffic details. The workload analyzer does not necessarily run continuously, it may run periodically or in any other pattern automatically or manually. The workload analyzer also does not necessarily collect network traffic details periodically, it may collect network traffic details during any time specified and/or customized by the user. The workload analyzer may collect network traffic details by using interfaces exported by the operating system. For example, commands such as netstat (in UNIX type systems) or APIs that can be used to get data programmatically within the analyzer. How the workload analyzer collect network traffic details may depend on the particular type of computer system, usage of the computer system, and/or other custom factors.

In an exemplary embodiment, during the period of time between each data collections, the workload analyzer may be put into sleep mode to save CPU cycles and lower performance penalties that may result from running the workload analyzer. For example, the workload analyzer may periodically captures traffic data on used interfaces and protocols like TCP and/or UDP, and sleep between each capture of traffic data. In one exemplary embodiment, the captured traffic information maybe stored in any number of ways, such as workload history databases, data structures, data files, etc. Certain workload patterns may be characterized by the captured and stored traffic information and these workload patterns may be useful in the tuning of the computer system. For example, web server traffic may be characterized by a very large number of TCP connections on the system and frequent opening and closing of a large number of collections. Similarly, backup or restore over the network may be characterized by large send-receive or receive-send packets ratios. On the other hand, OLTP kind of transactions may be characterized by receive-send packet ratios being close to one. The nature of the traffic data along with temporal characteristics may be stored in the history by the workload analyzer for the purpose of system tuning.

In another exemplary embodiment, the system tuner may periodically analyze the stored workload history, and based on the tuning policies set by the system administrator, the system tuner may either tune the system or advise the system administrator with a set of tunable parameters to choose such that the system administrator may manually tune the system. The time period between each analysis of the system tuner may vary depending on the particular need of the computer system. For example, a tuning policy may be set such that if the workload is of OLTP nature and the workload is observed for the last five minutes, then the system tuner may automatically tune the computer system to cater to an OLTP workload. Afterwards, the system tuner may analyze the current workload and the workload during the last 5 minutes and may decide to tune the system again if the workload is of OLTP type or leave the system tuning as it is. The actual tuning of different parameters is platform and operating system dependent. For example, system tuning for UNIX type systems may be ndd parameters or kernel tunable parameters. For non-UNIX type platforms, system tuning may involve other different types of parameters. In addition, various tuning parameters such as interrupt coalescence may be vendor and/or platform dependent.

It is understood that the herein described apparatus and methods are susceptible to various modifications and alternative constructions. There is no intention to limit the invention to the specific constructions described herein. To the contrary, the invention is intended to cover all modifications, alternative constructions, and equivalents falling within the scope and spirit of the invention.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention.

What is claimed is:

1. A method of automatically tuning a computer system, comprising the steps of:
collecting data relating to tuning a computer system, the data comprising network traffic data;
analyzing the data; and
determining if tuning is necessary.

2. The method as recited in claim 1, further comprising:
storing the collected data;
determining the workload of the computer system based on the collected data;
comparing the collected data with the stored data; and
determining if there is a change in workload of the computer system.

3. The method as recited in claim 2, further comprising:
determining if the system is tuned optimally for the current workload.

4. The method as recited in claim 1, further comprising:
if tuning is determined to be necessary, tuning the computer system based on the analysis of the data.

5. The method as recited in claim 1, further comprising:
providing tuning policies relating to timing of the computer system.

6. The method as recited in claim 5, further comprising:
if tuning is determined to be necessary, tuning the computer system based on the analysis of the data and the tuning policies.

7. The method as recited in claim 5, wherein the tuning policies comprises at least one of:
automatically tuning the computer system based on the analysis of the data;
providing a warning for an administrator when tuning is necessary;
providing recommendation on tuning the computer system; and
delaying action for a period of time.

8. The method as recited in claim 1, wherein the data relating to tuning a computer system further comprises at least one of:
network configurations, tuning parameters, LAN interfaces, interrupt configuration details, and interrupt coalescence values.

9. The method as recited in claim 1, further comprising:
periodically performing the collecting step, the analyzing step, and the determining step.

10. The method as recited in claim 9, further comprising:
putting into sleep mode between the periodic performance of the collecting step, the analyzing step and the determining steps.

11. A computer system, comprising a processor wherein the processor:
collects data relating to tuning a computer system, the data comprising network traffic data;
analyzes the data; and
determines if tuning is necessary.

12. The computer system as recited in claim 11, further comprising:
a storage medium for storing the collected data;
wherein the processor:
determines the workload of the computer system based on the collected data;
compares the collected data with the stored data; and
determines if there is a change in workload of the computer system.

13. The computer system as recited in claim 11, wherein the processor:
determines if the system is tuned optimally for the current workload.

14. The computer system as recited in claim 11, wherein the processor tunes the computer system based on the analysis of the data if tuning is determined to be necessary.

15. The computer system as recited in claim 12, wherein:
the storage medium stores tuning policies relating to tuning of the computer system.

16. The computer system as recited in claim 15, wherein:
the processor tunes the computer system based on the analysis of the data and the tuning policies.

17. The computer system as recited in claim 15, wherein the tuning policies comprises instructions for the processor to perform at least one of:
an automatic tuning of the computer system based on the analysis of the data;
a warning for an administrator when tuning is necessary;
a recommendation on tuning the computer system; and
a delay in action for a period of time.

18. The computer system as recited in claim 11, wherein the data relating to tuning a computer system further comprises at least one of:
network configurations, tuning parameters, LAN interfaces, interrupt configuration details, and interrupt coalescence values.

19. The computer system as recited in claim 11, wherein:
the processor periodically performs the collection, the analysis, and the determination.

20. The computer system as recited in claim 19, wherein:
at least part of the processor is put into sleep mode between the periodic performance of the collection, the analysis, and the determination.
